(19) United States
(12) Patent Application Publication
(10) Pub. No.: US 2019/0345830 A1
(43) Pub. Date: Nov. 14, 2019

(54) DAMPER

(71) Applicant: ROLLS-ROYCE plc, London (GB)

(72) Inventors: Luca PESARESI, London (GB); Loic SALLES, London (GB); Chian WONG, Derby (GB); Christoph W. SCHWINGSHACKL, Wargrave (GB); Adrian M. JONES, Bristol (GB)

(73) Assignee: ROLLS-ROYCE plc, London (GB)

(21) Appl. No.: 16/382,352

(22) Filed: Apr. 12, 2019

(30) Foreign Application Priority Data
May 8, 2018 (GB) 1807458.3

(51) Int. Cl. F01D 5/22; F01D 11/00

(52) U.S. Cl. CPC F01D 5/22; F05D 2220/32; F05D 2260/96; F01D 11/006

(57) ABSTRACT

An inter-blade vibration damper for a gas turbine engine has an elongate damper body. The damper body is formed as a truncated cone and has a longitudinal axis. The elongate damper body is formed as a truncated cone. A conic surface of the damper body contacts a portion of a first blade and a portion of an adjoining second blade.

### FIELD OF THE DISCLOSURE

The present disclosure relates to a vibration damper and particularly, but not exclusively, to a blade-to-blade vibration damper for a gas turbine engine.

### BACKGROUND TO THE DISCLOSURE

The turbine section of a gas turbine engine comprises one or more stages, with each stage consisting of a disc wheel and a circumferential array of turbine blades. The array of turbine blades is located in the disc wheel by some form of blade root attachment. Typically this is a fir-tree style retention arrangement although other geometrical attachments forms may be used.

In order to reduce oscillations or vibrations that may occur in the turbine blades during the normal operation of the gas turbine engine, it is known to position a damper element between the blade platforms of circumferentially adjoining blades. These damper elements are located radially beneath the blade platforms.

The turbine blade dampers achieve their damping function by dissipating frictional energy resulting from the relative movement between the adjacent blade pairs.

Conventional turbine blade dampers have either a wedge shaped cross-section (colloquially termed ‘cottage roof’ dampers) or a cylindrical cross-section. FIG. 4 shows an example of such a conventional ‘cottage roof’ damper. These ‘cottage roof’ style dampers may have symmetrical or asymmetrical cross-sectional profiles

A known problem with these conventional blade dampers is that they do not provide any significant damping to vibration modes that are characterised mainly by an opposing vertical (or radially inward and outward) motion of the two adjoining blade platforms. This is because in such current blade damper arrangements the damper tends to roll about its longitudinal axis (as illustrated in FIG. 5) and therefore the frictional dissipation occurring at the blade-damper interface is significantly reduced.

A further problem with conventional ‘cottage roof’ style dampers is the contact condition between the damper element and the corresponding blade platform may vary from one damper element to another. Furthermore, for an individual damper this contact condition may also vary between one loading cycle and another. This variation reduces the efficiency of the damper, and also makes computational modelling of the damper both unpredictable and inaccurate.

While the use of a cylindrical damper element can improve the contact efficiency between the damper element and the blade platform, this arrangement cannot provide damping to vibration modes characterised by opposing vertical motion of adjoining blades. This is because in this mode, the damper element simply rolls and provides no damping to the opposing blade motion.

### STATEMENTS OF DISCLOSURE

According to a first aspect of the present disclosure there is provided an inter-blade vibration damper for a gas turbine engine, comprising:
an elongate damper body having a longitudinal axis,

wherein the elongate damper body is formed with a conic surface, the conic surface of the damper body contacts a portion of a first blade and a portion of an adjoining second blade.

The conical surface form of the vibration damper of the present disclosure means that when it is positioned between two blade platforms the longitudinal axis of the vibration damper will not be parallel to the axis of rotation of the turbine disc. This in turn means that the radially opposing vertical motion of two adjacent blade platforms cannot generate a rolling motion of the vibration damper because the conical surface of the damper is constrained by the two blade platforms.

Consequently, in order to maintain physical contact between the vibration damper and the two platforms there must be a sliding motion at the damper-platform interface. This sliding motion between the damper and each platform will lead to frictional energy dissipation. This in turn makes the vibration damper of the present disclosure more effective than vibration dampers of the prior art.

The arrangement of a conical damper body provides a more effective damping behaviour since any relative motion between the adjoining blades results in sliding contact between the damper element and the blade platform. At the same time, the line contact between the damper element and the blade platform provides robust contact behaviour between the damper element and the blade platform.

Thus, in contrast to conventional ‘cottage roof’ or cylindrical blade dampers, the vibration damper of the present disclosure is able to effectively damp vibration modes, particularly those characterised by a radially opposing motion of two adjoining blade platforms.

Many vibration modes experienced by gas turbine engines during normal operation include vertical (radially inward and outward) platform motion. The ability of the vibration damper of the present disclosure to effectively damp this radial platform motion makes the vibration damper more effective than prior art damper arrangements.

Optionally, the conic surface is a truncated conic surface.

The use of a truncated cone geometry for the damper body makes the vibration damper of the present disclosure easier and more convenient for a user to package into a blade configuration.

Optionally, the truncated conic surface is a truncated circular conic surface.

An advantage of the vibration damper body being formed as a full cone is that it may be rotated around its longitudinal axis and still provide the requisite line contact with the two adjoining blade platforms.

The use of a circular cone makes the vibration damper easier to manufacture, which makes it more desirable for a user.

Optionally, the truncated circular conic surface has an included angle of between 4° and 60°.

Theoretical modelling of the kinematic slip of the vibration damper has shown that a range of cone included angles between 4° and 60° provides the most effective damper performance.

As the cone included angle increases then the resulting kinematic slip will also increase as illustrated, for example, in FIG. 8. However, this increase in kinematic slip results in an increased wear rate at the contact between the damper element and the blade platform. Consequently, the selection of included cone angle will be a compromise between the kinematic slip (corresponding to the damping performance) and the wear rate.

In an alternative arrangement the truncated circular cone has an included angle of between 20° and 45°.

Optionally, the truncated conic surface is a truncated elliptical conic surface, the truncated elliptical conic surface being oriented such that a major axis of the elliptical base of the truncated conic surface extends along a mid-plane between the first and second blades.

By forming the vibration damper as a truncated elliptical cone the vibration damper may be packaged into a smaller volume between the adjacent blade root regions. This enables the vibration damper of the present disclosure to be applied to more space-poor engine configurations.

Optionally, the conic surface extends partially around the longitudinal axis.

The vibration damper requires only sufficient conical surface to provide contact with the blade platform of each of the adjacent blades. The portion of the vibration damper body that is distal to the zone of contact with the blade platforms may therefore be removed while maintaining the effectiveness of the vibration damper at damping vertical motion of the blades. In other words, the vibration damper may have the form of a partial truncated cone.

The removal of material from the damper body will reduce the mass of the damper body. Since the damper body is subject to the centrifugal loading produced by the rotation of the blades, the ability to select a pre-determined mass for the damper body will simplify the process of optimising the overall damper design.

In one arrangement, the damper body has a conic surface formed by the intersection of a plane with the surface of a cone, and in which the intersection is offset from the centreline of the cone; the damper body being formed by the smaller portion of the cone.

In an alternative arrangement, the conic surface is formed by simply reducing the circumferential extent of the truncated cone around the longitudinal axis.

Optionally, the conic surface extends as a half cone from a mid-plane through the longitudinal axis.

In one arrangement, the vibration damper may be a half cone, i.e. the conic surface extends across 180° around the longitudinal axis. This arrangement is simple to produce, i.e. by dividing the cone along a centre plane.

In other arrangements, the vibration damper may have a conic surface that extends across an angle other than 180° around the longitudinal axis. Such an alternative may be more difficult to manufacture than a half cone arrangement.

Optionally, the conic surface is provided with a surface roughness Ra in the range of 0.1 to 50 μm.

As outlined above the geometrical mismatch between the axis of vibration damper and the radial direction of movement of the blades causes a sliding motion between the blade platform and the vibration damper. This sliding motion requires a degree of friction between the contacting surfaces in order to generate a frictional force and thus to dissipate frictional energy.

Providing the conic surface with a surface roughness Ra in the range of 0.1 to 50 μm ensures that the contacting surfaces can generate the required frictional force.

According to a second aspect of the present disclosure there is provided a rotor device for a gas turbine engine comprising:
a disc wheel;
at least two blades extending radially from the disc wheel; and
at least one vibration damper according to the first aspect.

The rotor device may be a turbine assembly of a gas turbine engine.

Optionally, the longitudinal axis of the elongate damper body subtends an angle with an axis of rotation of the disc wheel.

Since the longitudinal axis of the damper intersects the axis of rotation of the disc wheel then the opposing radially directed motion (i.e. normal to the axis of rotation of the disc wheel) of two adjacent blade platforms will result in a relative sliding motion between the blade platforms and the interposing damper element.

According to a third aspect of the present disclosure there is provided a gas turbine engine for an aircraft comprising:
an engine core comprising a turbine, a compressor, and a core shaft connecting the turbine to the compressor;
a fan located upstream of the engine core, the fan comprising a plurality of fan blades; and
a gearbox that receives an input from the core shaft and outputs drive to the fan so as to drive the fan at a lower rotational speed than the core shaft,
wherein at least one of the turbine and the compressor comprises a rotor device according to the second aspect.

Optionally, the turbine is a first turbine, the compressor is a first compressor, and the core shaft is a first core shaft;
the engine core further comprises a second turbine, a second compressor, and a second core shaft connecting the second turbine to the second compressor; and
the second turbine, second compressor, and second core shaft are arranged to rotate at a higher rotational speed than the first core shaft.

As noted elsewhere herein, the present disclosure may relate to a gas turbine engine. Such a gas turbine engine may comprise an engine core comprising a turbine, a combustor, a compressor, and a core shaft connecting the turbine to the compressor. Such a gas turbine engine may comprise a fan (having fan blades) located upstream of the engine core.

Arrangements of the present disclosure may be particularly, although not exclusively, beneficial for fans that are driven via a gearbox. Accordingly, the gas turbine engine may comprise a gearbox that receives an input from the core shaft and outputs drive to the fan so as to drive the fan at a lower rotational speed than the core shaft. The input to the gearbox may be directly from the core shaft, or indirectly from the core shaft, for example via a spur shaft and/or gear. The core shaft may rigidly connect the turbine and the compressor, such that the turbine and compressor rotate at the same speed (with the fan rotating at a lower speed).

The gas turbine engine as described and/or claimed herein may have any suitable general architecture. For example, the gas turbine engine may have any desired number of shafts that connect turbines and compressors, for example one, two or three shafts. Purely by way of example, the turbine connected to the core shaft may be a first turbine, the compressor connected to the core shaft may be a first compressor, and the core shaft may be a first core shaft. The engine core may further comprise a second turbine, a second compressor, and a second core shaft connecting the second turbine to the second compressor. The second turbine, second compressor, and second core shaft may be arranged to rotate at a higher rotational speed than the first core shaft.

In such an arrangement, the second compressor may be positioned axially downstream of the first compressor. The second compressor may be arranged to receive (for example directly receive, for example via a generally annular duct) flow from the first compressor.

The gearbox may be arranged to be driven by the core shaft that is configured to rotate (for example in use) at the lowest rotational speed (for example the first core shaft in the example above). For example, the gearbox may be arranged to be driven only by the core shaft that is configured to rotate (for example in use) at the lowest rotational speed (for example only be the first core shaft, and not the second core shaft, in the example above). Alternatively, the gearbox may be arranged to be driven by any one or more shafts, for example the first and/or second shafts in the example above.

In any gas turbine engine as described and/or claimed herein, a combustor may be provided axially downstream of the fan and compressor(s). For example, the combustor may be directly downstream of (for example at the exit of) the second compressor, where a second compressor is provided. By way of further example, the flow at the exit to the combustor may be provided to the inlet of the second turbine, where a second turbine is provided. The combustor may be provided upstream of the turbine(s).

The or each compressor (for example the first compressor and second compressor as described above) may comprise any number of stages, for example multiple stages. Each stage may comprise a row of rotor blades and a row of stator vanes, which may be variable stator vanes (in that their angle of incidence may be variable). The row of rotor blades and the row of stator vanes may be axially offset from each other.

The or each turbine (for example the first turbine and second turbine as described above) may comprise any number of stages, for example multiple stages. Each stage may comprise a row of rotor blades and a row of stator vanes. The row of rotor blades and the row of stator vanes may be axially offset from each other.

Each fan blade may be defined as having a radial span extending from a root (or hub) at a radially inner gas-washed location, or 0% span position, to a tip at a 100% span position. The ratio of the radius of the fan blade at the hub to the radius of the fan blade at the tip may be less than (or on the order of) any of: 0.4, 0.39, 0.38 0.37, 0.36, 0.35, 0.34, 0.33, 0.32, 0.31, 0.3, 0.29, 0.28, 0.27, 0.26, or 0.25. The ratio of the radius of the fan blade at the hub to the radius of the fan blade at the tip may be in an inclusive range bounded by any two of the values in the previous sentence (i.e. the values may form upper or lower bounds). These ratios may commonly be referred to as the hub-to-tip ratio. The radius at the hub and the radius at the tip may both be measured at the leading edge (or axially forwardmost) part of the blade. The hub-to-tip ratio refers, of course, to the gas-washed portion of the fan blade, i.e. the portion radially outside any platform.

The radius of the fan may be measured between the engine centreline and the tip of a fan blade at its leading edge. The fan diameter (which may simply be twice the radius of the fan) may be greater than (or on the order of) any of: 250 cm (around 100 inches), 260 cm, 270 cm (around 105 inches), 280 cm (around 110 inches), 290 cm (around 115 inches), 300 cm (around 120 inches), 310 cm, 320 cm (around 125 inches), 330 cm (around 130 inches), 340 cm (around 135 inches), 350 cm, 360 cm (around 140 inches), 370 cm (around 145 inches), 380 (around 150 inches) cm or 390 cm (around 155 inches). The fan diameter may be in an inclusive range bounded by any two of the values in the previous sentence (i.e. the values may form upper or lower bounds).

The rotational speed of the fan may vary in use. Generally, the rotational speed is lower for fans with a higher diameter. Purely by way of non-limitative example, the rotational speed of the fan at cruise conditions may be less than 2500 rpm, for example less than 2300 rpm. Purely by way of further non-limitative example, the rotational speed of the fan at cruise conditions for an engine having a fan diameter in the range of from 250 cm to 300 cm (for example 250 cm to 280 cm) may be in the range of from 1700 rpm to 2500 rpm, for example in the range of from 1800 rpm to 2300 rpm, for example in the range of from 1900 rpm to 2100 rpm. Purely by way of further non-limitative example, the rotational speed of the fan at cruise conditions for an engine having a fan diameter in the range of from 320 cm to 380 cm may be in the range of from 1200 rpm to 2000 rpm, for example in the range of from 1300 rpm to 1800 rpm, for example in the range of from 1400 rpm to 1600 rpm.

In use of the gas turbine engine, the fan (with associated fan blades) rotates about a rotational axis. This rotation results in the tip of the fan blade moving with a velocity Uₜᵢₚ. The work done by the fan blades 13 on the flow results in an enthalpy rise dH of the flow. A fan tip loading may be defined as dH/Uₜᵢₚ², where dH is the enthalpy rise (for example the 1-D average enthalpy rise) across the fan and Uₜᵢₚ is the (translational) velocity of the fan tip, for example at the leading edge of the tip (which may be defined as fan tip radius at leading edge multiplied by angular speed). The fan tip loading at cruise conditions may be greater than (or on the order of) any of: 0.3, 0.31, 0.32, 0.33, 0.34, 0.35, 0.36, 0.37, 0.38, 0.39 or 0.4 (all units in this paragraph being Jkg⁻¹K⁻¹/(ms⁻¹)²). The fan tip loading may be in an inclusive range bounded by any two of the values in the previous sentence (i.e. the values may form upper or lower bounds).

Gas turbine engines in accordance with the present disclosure may have any desired bypass ratio, where the bypass ratio is defined as the ratio of the mass flow rate of the flow through the bypass duct to the mass flow rate of the flow through the core at cruise conditions. In some arrangements the bypass ratio may be greater than (or on the order of) any of the following: 10, 10.5, 11, 11.5, 12, 12.5, 13, 13.5, 14, 14.5, 15, 15.5, 16, 16.5, or 17. The bypass ratio may be in an inclusive range bounded by any two of the values in the previous sentence (i.e. the values may form upper or lower bounds). The bypass duct may be substantially annular. The bypass duct may be radially outside the core engine. The radially outer surface of the bypass duct may be defined by a nacelle and/or a fan case.

The overall pressure ratio of a gas turbine engine as described and/or claimed herein may be defined as the ratio of the stagnation pressure upstream of the fan to the stagnation pressure at the exit of the highest pressure compressor (before entry into the combustor). By way of non-limitative example, the overall pressure ratio of a gas turbine engine as described and/or claimed herein at cruise may be greater than (or on the order of) any of the following: 35, 40, 45, 50, 55, 60, 65, 70, 75. The overall pressure ratio may be in an inclusive range bounded by any two of the values in the previous sentence (i.e. the values may form upper or lower bounds).

Specific thrust of an engine may be defined as the net thrust of the engine divided by the total mass flow through the engine. At cruise conditions, the specific thrust of an engine described and/or claimed herein may be less than (or on the order of) any of the following: 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust may be in an inclusive range bounded by any two of the values in the previous sentence (i.e. the values may form upper or lower bounds). Such engines may be particularly efficient in comparison with conventional gas turbine engines.

A gas turbine engine as described and/or claimed herein may have any desired maximum thrust. Purely by way of non-limitative example, a gas turbine as described and/or claimed herein may be capable of producing a maximum thrust of at least (or on the order of) any of the following: 160 kN, 170 kN, 180 kN, 190 kN, 200 kN, 250 kN, 300 kN, 350 kN, 400 kN, 450 kN, 500 kN, or 550 kN. The maximum thrust may be in an inclusive range bounded by any two of the values in the previous sentence (i.e. the values may form upper or lower bounds). The thrust referred to above may be the maximum net thrust at standard atmospheric conditions at sea level plus 15 deg C. (ambient pressure 101.3 kPa, temperature 30 deg C.), with the engine static.

In use, the temperature of the flow at the entry to the high pressure turbine may be particularly high. This temperature, which may be referred to as TET, may be measured at the exit to the combustor, for example immediately upstream of the first turbine vane, which itself may be referred to as a nozzle guide vane. At cruise, the TET may be at least (or on the order of) any of the following: 1400K, 1450K, 1500K, 1550K, 1600K or 1650K. The TET at cruise may be in an inclusive range bounded by any two of the values in the previous sentence (i.e. the values may form upper or lower bounds). The maximum TET in use of the engine may be, for example, at least (or on the order of) any of the following: 1700K, 1750K, 1800K, 1850K, 1900K, 1950K or 2000K. The maximum TET may be in an inclusive range bounded by any two of the values in the previous sentence (i.e. the values may form upper or lower bounds). The maximum TET may occur, for example, at a high thrust condition, for example at a maximum take-off (MTO) condition.

A fan blade and/or aerofoil portion of a fan blade described and/or claimed herein may be manufactured from any suitable material or combination of materials. For example at least a part of the fan blade and/or aerofoil may be manufactured at least in part from a composite, for example a metal matrix composite and/or an organic matrix composite, such as carbon fibre. By way of further example at least a part of the fan blade and/or aerofoil may be manufactured at least in part from a metal, such as a titanium based metal or an aluminium based material (such as an aluminium-lithium alloy) or a steel based material. The fan blade may comprise at least two regions manufactured using different materials. For example, the fan blade may have a protective leading edge, which may be manufactured using a material that is better able to resist impact (for example from birds, ice or other material) than the rest of the blade. Such a leading edge may, for example, be manufactured using titanium or a titanium-based alloy. Thus, purely by way of example, the fan blade may have a carbon-fibre or aluminium based body (such as an aluminium lithium alloy) with a titanium leading edge.

A fan as described and/or claimed herein may comprise a central portion, from which the fan blades may extend, for example in a radial direction. The fan blades may be attached to the central portion in any desired manner. For example, each fan blade may comprise a fixture which may engage a corresponding slot in the hub (or disc). Purely by way of example, such a fixture may be in the form of a dovetail that may slot into and/or engage a corresponding slot in the hub/disc in order to fix the fan blade to the hub/disc. By way of further example, the fan blades maybe formed integrally with a central portion. Such an arrangement may be referred to as a bladed disc or a bladed ring. Any suitable method may be used to manufacture such a bladed disc or bladed ring. For example, at least a part of the fan blades may be machined from a block and/or at least part of the fan blades may be attached to the hub/disc by welding, such as linear friction welding.

The gas turbine engines described and/or claimed herein may or may not be provided with a variable area nozzle (VAN). Such a variable area nozzle may allow the exit area of the bypass duct to be varied in use. The general principles of the present disclosure may apply to engines with or without a VAN.

The fan of a gas turbine as described and/or claimed herein may have any desired number of fan blades, for example 16, 18, 20, or 22 fan blades.

As used herein, cruise conditions may mean cruise conditions of an aircraft to which the gas turbine engine is attached. Such cruise conditions may be conventionally defined as the conditions at mid-cruise, for example the conditions experienced by the aircraft and/or engine at the midpoint (in terms of time and/or distance) between top of climb and start of decent.

Purely by way of example, the forward speed at the cruise condition may be any point in the range of from Mach 0.7 to 0.9, for example 0.75 to 0.85, for example 0.76 to 0.84, for example 0.77 to 0.83, for example 0.78 to 0.82, for example 0.79 to 0.81, for example on the order of Mach 0.8, on the order of Mach 0.85 or in the range of from 0.8 to 0.85. Any single speed within these ranges may be the cruise condition. For some aircraft, the cruise conditions may be outside these ranges, for example below Mach 0.7 or above Mach 0.9.

Purely by way of example, the cruise conditions may correspond to standard atmospheric conditions at an altitude that is in the range of from 10000 m to 15000 m, for example in the range of from 10000 m to 12000 m, for example in the range of from 10400 m to 11600 m (around 38000 ft), for example in the range of from 10500 m to 11500 m, for example in the range of from 10600 m to 11400 m, for example in the range of from 10700 m (around 35000 ft) to 11300 m, for example in the range of from 10800 m to 11200 m, for example in the range of from 10900 m to 11100 m, for example on the order of 11000 m. The cruise conditions may correspond to standard atmospheric conditions at any given altitude in these ranges.

Purely by way of example, the cruise conditions may correspond to: a forward Mach number of 0.8; a pressure of 23000 Pa; and a temperature of −55 deg C.

As used anywhere herein, “cruise” or “cruise conditions” may mean the aerodynamic design point. Such an aerodynamic design point (or ADP) may correspond to the conditions (comprising, for example, one or more of the Mach Number, environmental conditions and thrust requirement) for which the fan is designed to operate. This may mean, for example, the conditions at which the fan (or gas turbine engine) is designed to have optimum efficiency.

In use, a gas turbine engine described and/or claimed herein may operate at the cruise conditions defined elsewhere herein. Such cruise conditions may be determined by the cruise conditions (for example the mid-cruise conditions) of an aircraft to which at least one (for example 2 or 4) gas turbine engine may be mounted in order to provide propulsive thrust.

The skilled person will appreciate that except where mutually exclusive, a feature or parameter described in relation to any one of the above aspects may be applied to any other aspect. Furthermore, except where mutually exclusive, any feature or parameter described herein may be applied to any aspect and/or combined with any other feature or parameter described herein.

Other aspects of the disclosure provide devices, methods and systems which include and/or implement some or all of the actions described herein. The illustrative aspects of the disclosure are designed to solve one or more of the problems herein described and/or one or more other problems not discussed.

### BRIEF DESCRIPTION OF THE DRAWINGS

There now follows a description of an embodiment of the disclosure, by way of non-limiting example, with reference being made to the accompanying drawings in which:

FIG. 1 is a sectional side view of a gas turbine engine;

FIG. 2 is a close up sectional side view of an upstream portion of a gas turbine engine;

FIG. 3 is a partially cut-away view of a gearbox for a gas turbine engine;

FIG. 4 shows a partial schematic view of a turbine blade damper according to the prior art;

FIG. 5 shows the damper arrangement of FIG. 4 in use with the vibration damper experiencing rotation;

FIG. 6 shows a schematic partial perspective view of a vibration damper arrangement according to a first embodiment of the disclosure;

FIG. 7 shows a schematic partial side view of the vibration damper of FIG. 6;

FIG. 8 illustrates the relationship between kinematic slip and cone included angle for the vibration damper of FIGS. 6 and 7;

FIG. 9 shows a schematic partial perspective view of a vibration damper arrangement according to a second embodiment of the disclosure;

FIG. 10 shows a schematic partial side view of the vibration damper of FIG. 9;

FIG. 11 shows a schematic partial perspective view of a vibration damper arrangement according to a third embodiment of the disclosure;

FIG. 12 shows a schematic partial side view of the vibration damper of FIG. 11;

FIG. 13 is a perspective view of the vibration damper of FIG. 6;

FIG. 14 is a perspective view of the vibration damper of FIG. 9; and

FIG. 15 is a perspective view of the vibration damper of FIG. 11;

It is noted that the drawings may not be to scale. The drawings are intended to depict only typical aspects of the disclosure, and therefore should not be considered as limiting the scope of the disclosure. In the drawings, like numbering represents like elements between the drawings.

### DETAILED DESCRIPTION

FIG. 1 illustrates a gas turbine engine 10 having a principal rotational axis 9. The engine 10 comprises an air intake 12 and a propulsive fan 23 that generates two airflows: a core airflow A and a bypass airflow B. The gas turbine engine 10 comprises a core 11 that receives the core airflow A. The engine core 11 comprises, in axial flow series, a low pressure compressor 14, a high-pressure compressor 15, combustion equipment 16, a high-pressure turbine 17, a low pressure turbine 19 and a core exhaust nozzle 20. A nacelle 21 surrounds the gas turbine engine 10 and defines a bypass duct 22 and a bypass exhaust nozzle 18. The bypass airflow B flows through the bypass duct 22. The fan 23 is attached to and driven by the low pressure turbine 19 via a shaft 26 and an epicyclic gearbox 30.

In use, the core airflow A is accelerated and compressed by the low pressure compressor 14 and directed into the high pressure compressor 15 where further compression takes place. The compressed air exhausted from the high pressure compressor 15 is directed into the combustion equipment 16 where it is mixed with fuel and the mixture is combusted. The resultant hot combustion products then expand through, and thereby drive, the high pressure and low pressure turbines 17, 19 before being exhausted through the nozzle 20 to provide some propulsive thrust. The high pressure turbine 17 drives the high pressure compressor 15 by a suitable interconnecting shaft 27. The fan 23 generally provides the majority of the propulsive thrust. The epicyclic gearbox 30 is a reduction gearbox.

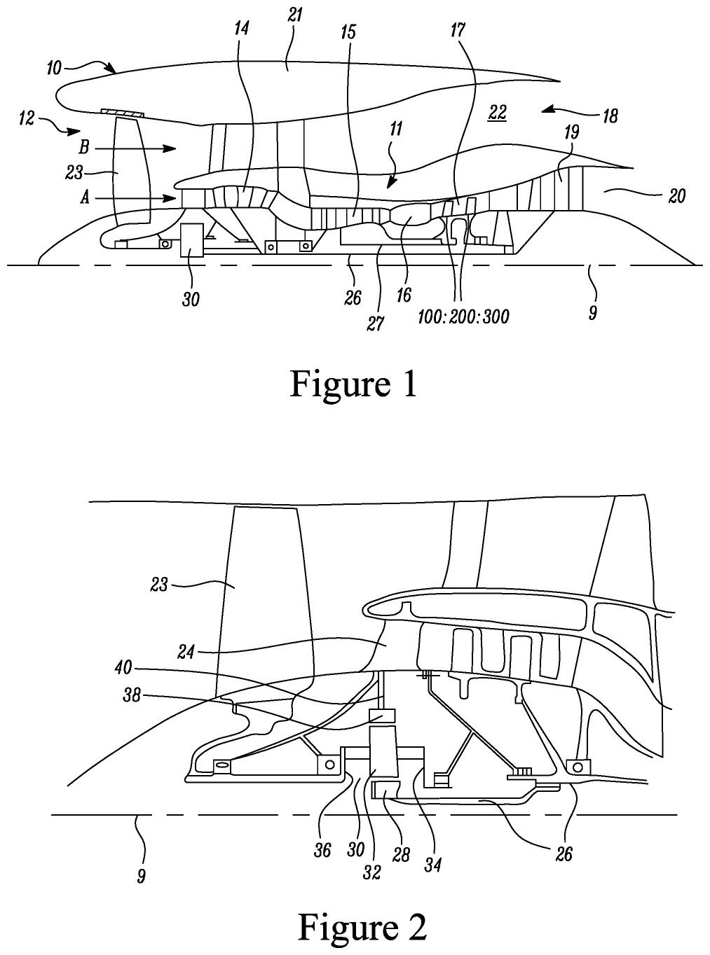

An exemplary arrangement for a geared fan gas turbine engine 10 is shown in FIG. 2. The low pressure turbine 19 (see FIG. 1) drives the shaft 26, which is coupled to a sun wheel, or sun gear, 28 of the epicyclic gear arrangement 30. Radially outwardly of the sun gear 28 and intermeshing therewith is a plurality of planet gears 32 that are coupled together by a planet carrier 34. The planet carrier 34 constrains the planet gears 32 to precess around the sun gear 28 in synchronicity whilst enabling each planet gear 32 to rotate about its own axis. The planet carrier 34 is coupled via linkages 36 to the fan 23 in order to drive its rotation about the engine axis 9. Radially outwardly of the planet gears 32 and intermeshing therewith is an annulus or ring gear 38 that is coupled, via linkages 40, to a stationary supporting structure 24.

Note that the terms “low pressure turbine” and “low pressure compressor” as used herein may be taken to mean the lowest pressure turbine stages and lowest pressure compressor stages (i.e. not including the fan 23) respectively and/or the turbine and compressor stages that are connected together by the interconnecting shaft 26 with the lowest rotational speed in the engine (i.e. not including the gearbox output shaft that drives the fan 23). In some literature, the “low pressure turbine” and “low pressure compressor” referred to herein may alternatively be known as the “intermediate pressure turbine” and “intermediate pressure compressor”. Where such alternative nomenclature is used, the fan 23 may be referred to as a first, or lowest pressure, compression stage.

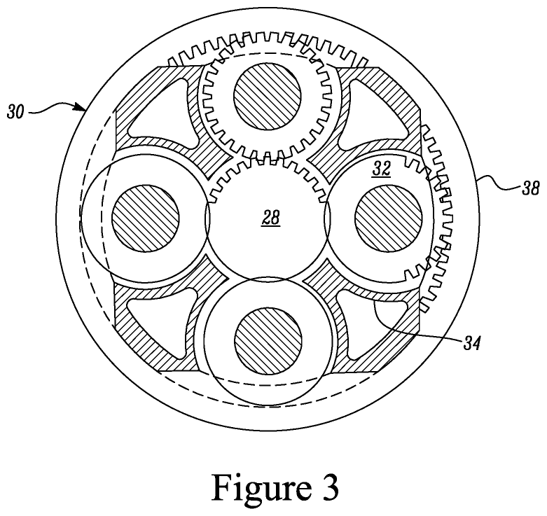

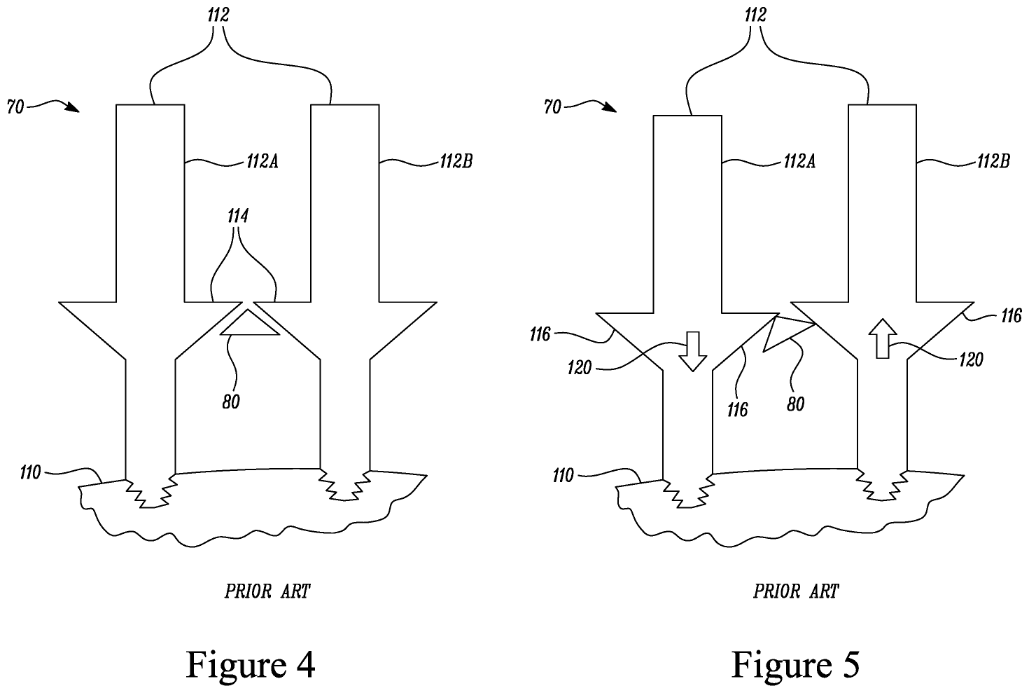

The epicyclic gearbox 30 is shown by way of example in greater detail in FIG. 3. Each of the sun gear 28, planet gears 32 and ring gear 38 comprise teeth about their periphery to intermesh with the other gears. However, for clarity only exemplary portions of the teeth are illustrated in FIG. 3. There are four planet gears 32 illustrated, although it will be apparent to the skilled reader that more or fewer planet gears 32 may be provided within the scope of the claimed invention. Practical applications of a planetary epicyclic gearbox 30 generally comprise at least three planet gears 32.

The epicyclic gearbox 30 illustrated by way of example in FIGS. 2 and 3 is of the planetary type, in that the planet carrier 34 is coupled to an output shaft via linkages 36, with the ring gear 38 fixed. However, any other suitable type of epicyclic gearbox 30 may be used. By way of further example, the epicyclic gearbox 30 may be a star arrangement, in which the planet carrier 34 is held fixed, with the ring (or annulus) gear 38 allowed to rotate. In such an arrangement the fan 23 is driven by the ring gear 38. By way of further alternative example, the gearbox 30 may be a differential gearbox in which the ring gear 38 and the planet carrier 34 are both allowed to rotate.

It will be appreciated that the arrangement shown in FIGS. 2 and 3 is by way of example only, and various alternatives are within the scope of the present disclosure. Purely by way of example, any suitable arrangement may be used for locating the gearbox 30 in the engine 10 and/or for connecting the gearbox 30 to the engine 10. By way of further example, the connections (such as the linkages 36, 40 in the FIG. 2 example) between the gearbox 30 and other parts of the engine 10 (such as the input shaft 26, the output shaft and the fixed structure 24) may have any desired degree of stiffness or flexibility. By way of further example, any suitable arrangement of the bearings between rotating and stationary parts of the engine (for example between the input and output shafts from the gearbox and the fixed structures, such as the gearbox casing) may be used, and the disclosure is not limited to the exemplary arrangement of FIG. 2. For example, where the gearbox 30 has a star arrangement (described above), the skilled person would readily understand that the arrangement of output and support linkages and bearing locations would typically be different to that shown by way of example in FIG. 2.

Accordingly, the present disclosure extends to a gas turbine engine having any arrangement of gearbox styles (for example star or planetary), support structures, input and output shaft arrangement, and bearing locations.

Optionally, the gearbox may drive additional and/or alternative components (e.g. the intermediate pressure compressor and/or a booster compressor).

Other gas turbine engines to which the present disclosure may be applied may have alternative configurations. For example, such engines may have an alternative number of compressors and/or turbines and/or an alternative number of interconnecting shafts.

By way of further example, the gas turbine engine shown in FIG. 1 has a split flow nozzle 20, 22 meaning that the flow through the bypass duct 22 has its own nozzle that is separate to and radially outside the core engine nozzle 20. However, this is not limiting, and any aspect of the present disclosure may also apply to engines in which the flow through the bypass duct 22 and the flow through the core 11 are mixed, or combined, before (or upstream of) a single nozzle, which may be referred to as a mixed flow nozzle. One or both nozzles (whether mixed or split flow) may have a fixed or variable area. Whilst the described example relates to a turbofan engine, the disclosure may apply, for example, to any type of gas turbine engine, such as an open rotor (in which the fan stage is not surrounded by a nacelle) or turboprop engine, for example. In some arrangements, the gas turbine engine 10 may not comprise a gearbox 30.

The geometry of the gas turbine engine 10, and components thereof, is defined by a conventional axis system, comprising an axial direction (which is aligned with the rotational axis 9), a radial direction (in the bottom-to-top direction in FIG. 1), and a circumferential direction (perpendicular to the page in the FIG. 1 view). The axial, radial and circumferential directions are mutually perpendicular.

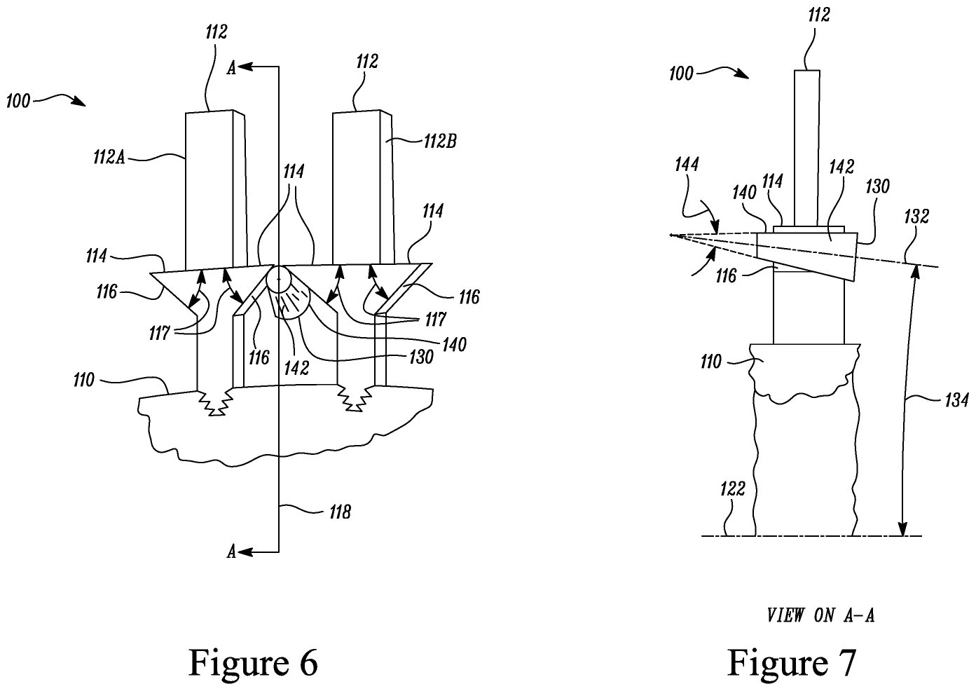

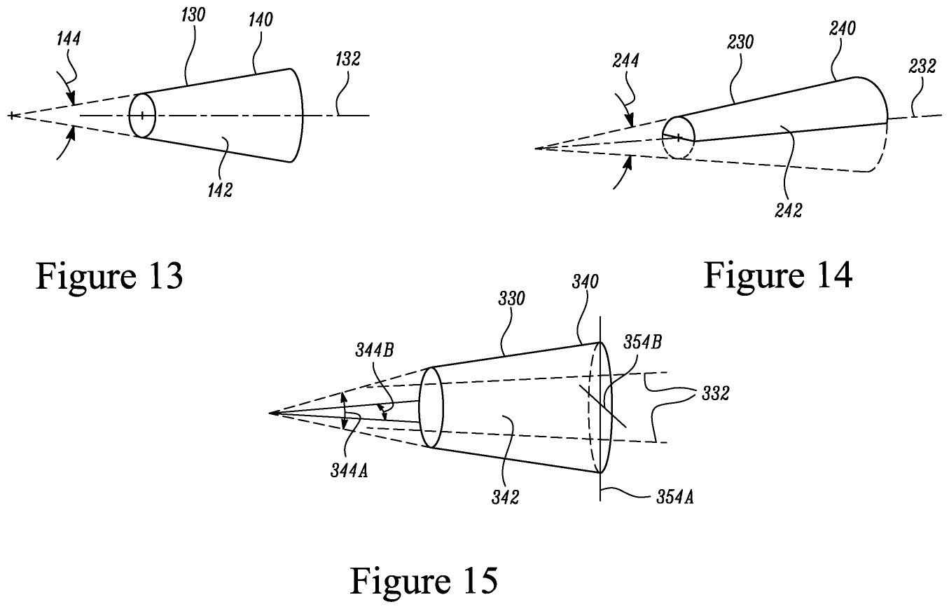

Referring to FIGS. 6, 7, and 13, a vibration damper according to a first embodiment of the disclosure is designated generally by the reference numeral 100, the holder

The vibration damper 100 has an elongate damper body 130. The damper body 130 is positioned circumferentially between two adjacent turbine blades 112A,112B that are attached to a turbine rotor 110. Each of the turbine blades 112A, 112B has a blade platform 114. The blade platform 114 extends laterally from the base of each of the blades in a circumferential direction. The radially outward surface of the blade platforms 114 co-operate to form a contiguous surface extending around a circumference of the rotor 110.

Each of the blade platforms 114 has an underside 116 in a radial sense. The underside 116 of each platform is angled in a radially outward sense extending from the respective blade 112 towards each adjoining blade 112. This blade platform angle 117 is shown in FIG. 6.

The damper body 130 has a longitudinal axis 132. The damper body 130 is formed as a truncated circular cone 140 having a conic surface 142. The conic surface 142 contacts the underside 116 of a platform 114 of a first blade 112A, and the underside of a platform 114 of an adjoining second blade 112B.

The longitudinal axis 132 of the damper body 130 is aligned with a plane extending along the joint between the first blade 112A and the second blade 112B.

Since the conic surface 142 of the damper body 130 contacts the underside 116 of each of the pair of adjoining platforms 114, the longitudinal axis 132 of the damper body 130 must be inclined relative to a rotational axis of the rotor 110. This inclination 134 is illustrated in FIG. 7.

In this arrangement, the damper body 130 has an included angle 144 of 30°. In other arrangements, this included angle may be between approximately 4° and 60°.

In use, as each of an adjoining pair of turbine blades 112 undergoes opposing radially directed motion (as illustrated in FIG. 5) the underside 116 of each turbine blade platform 114 will be forced to slide against the corresponding conic surface 142 of the damper body 130. This sliding motion will result in the frictional dissipation of vibrational energy.

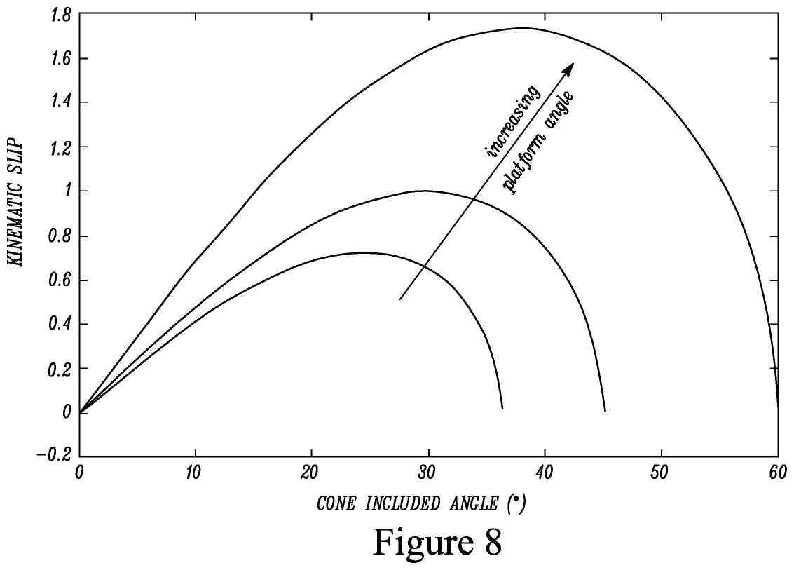

FIG. 8 illustrates the relationship between the included angle of the conic surface of the damper body and the degree of kinematic slip between the conic surface and the abutting turbine blade platform for a range of damper platform angles. FIG. 8 shows that for a given included angle, an increase in platform angle will produce increased slip between the damper body and the blade platform.

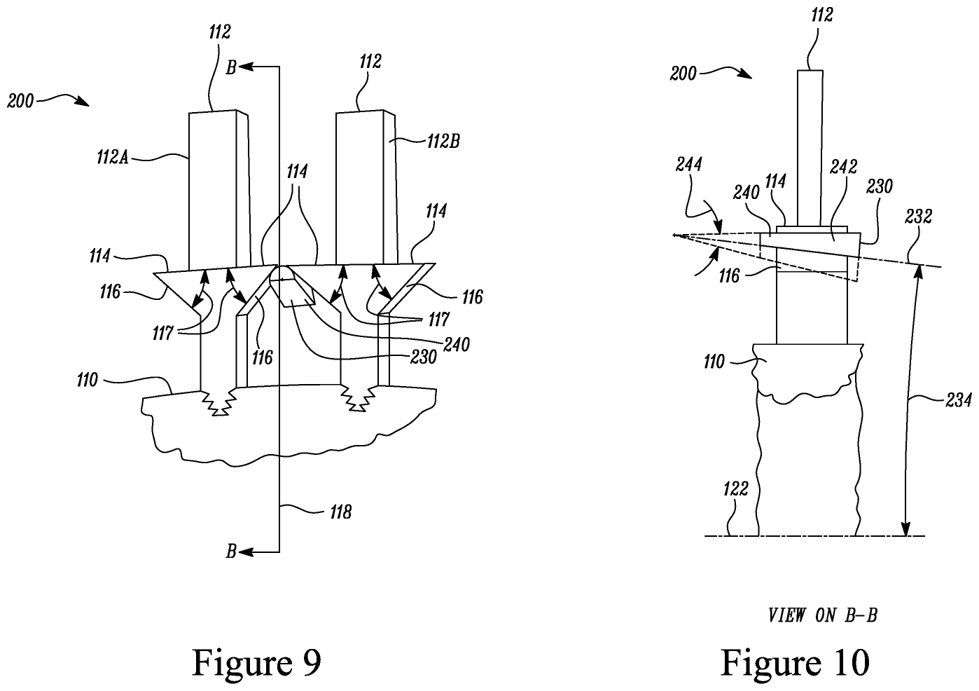

Referring to FIGS. 9, 10, and 14, a vibration damper according to a second embodiment of the disclosure is designated generally by the reference numeral 200. Features of the vibration damper 200 which correspond to those of vibration damper 100 have been given corresponding reference numerals for ease of reference.

The vibration damper 200 is positioned between the undersides 116 of the blade platforms 114 of two adjoining turbine blades 112A,112B in the same way as outlined above for the first embodiment 100.

The vibration damper 200 comprises an elongate damper body 230 having a longitudinal axis 232. The elongate damper body 230 is formed as a half truncated circular cone 240. The half truncated circular cone 240 has a conic surface 242. The conic surface 242 has an included angle 244.

In the same way as outlined above for the first embodiment, the conic surface 242 abuts the underside 116 of the blade platform 114 of each adjoining pair of turbine blades 112A,112B. The longitudinal axis 232 is inclined relative to the axis of rotation 122 of the rotor 110.

In use, radially directed relative motion between adjoining turbine blades 112A,112B causes a sliding motion between the underside 116 of each blade platform 114 and the corresponding conic surface 242. This sliding motion results in the frictional dissipation of vibrational energy and hence damps this radial blade movement.

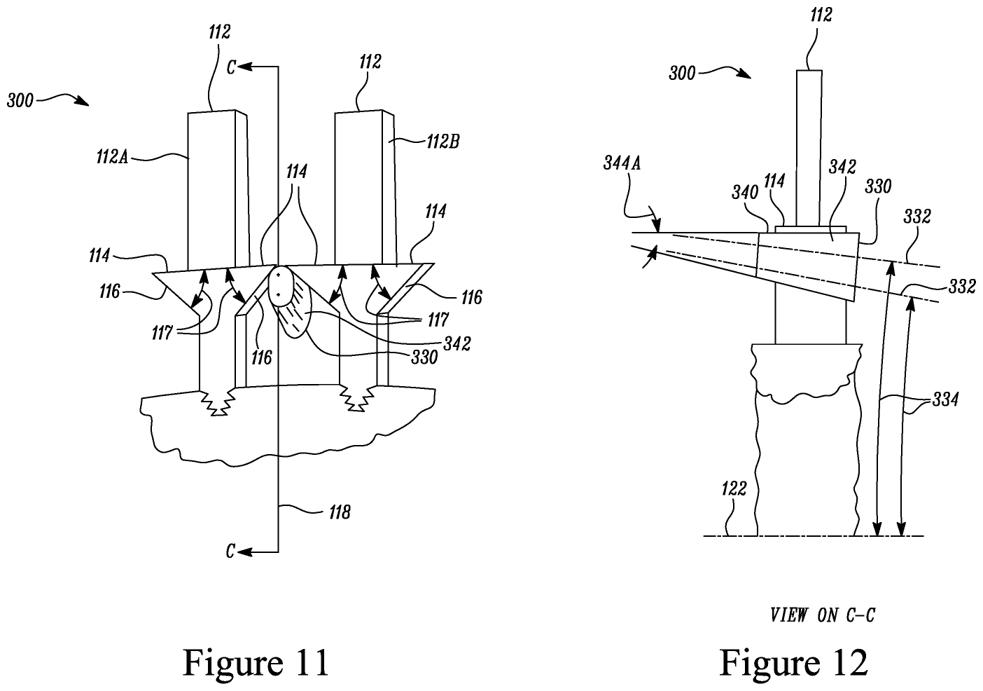

Referring to FIGS. 11, 12, and 15, a vibration damper according to a third embodiment of the disclosure is designated generally by the reference numeral 300. Features of the vibration damper 300 which correspond to those of vibration damper 100 have been given corresponding reference numerals for ease of reference.

The vibration damper 300 is positioned between the undersides 116 of the blade platforms 114 of two adjoining turbine blades 112A,112B in the same way as outlined above for the first embodiment 100.

The vibration damper 300 comprises an elongate damper body 330 having a longitudinal axis 332. The elongate damper body 330 is formed as an elliptical cone 340. The elliptical cone 340 has a conic surface 342. The conic surface 342 has a major included angle 344A, and a minor included angle 344B.

In the same way as outlined above for the first embodiment, the conic surface 342 abuts the underside 116 of the blade platform 114 of each adjoining pair of turbine blades 112A,112B. The longitudinal axis 332 is inclined relative to the axis of rotation 122 of the rotor 110.

In use, radially directed relative motion between adjoining turbine blades 112A,112B causes a sliding motion between the underside 116 of each blade platform 114 and the corresponding conic surface 342. This sliding motion results in the frictional dissipation of vibrational energy and hence damps this radial blade movement.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting.

Moreover, in determining extent of protection, due account shall be taken of any element which is equivalent to an element specified in the claims. Various changes to the described embodiments may be made without departing from the scope of the invention.

In addition, where a range of values is provided, it is understood that every intervening value, between the upper and lower limit of that range and any other stated or intervening value in that stated range, is encompassed within the invention.

Except where mutually exclusive, any of the features may be employed separately or in combination with any other features and the disclosure extends to and includes all combinations and sub-combinations of one or more features described herein.

The foregoing description of various aspects of the disclosure has been presented for purposes of illustration and description. It is not intended to be exhaustive or to limit the disclosure to the precise form disclosed, and obviously, many modifications and variations are possible. Such modifications and variations that may be apparent to a person of skill in the art are included within the scope of the disclosure as defined by the accompanying claims.

1. An inter-blade vibration damper for a gas turbine engine, comprising:
an elongate damper body having a longitudinal axis,
wherein the elongate damper body is formed with a conic surface, the conic surface of the damper body contacts a portion of a first blade and a portion of an adjoining second blade.

2. The vibration damper as claimed in claim 1, wherein the conic surface is a truncated conic surface.

3. The vibration damper as claimed in claim 2, wherein the truncated conic surface is a truncated circular conic surface.

4. The vibration damper as claimed in claim 2, wherein the truncated conic surface has an included angle of between 4° and 60°.

5. The vibration damper as claimed in claim 2, wherein the truncated conic surface is a truncated elliptical conic surface, the truncated elliptical conic suface being oriented such that a major axis of the elliptical base of the truncated conic surface extends along a mid-plane between the first and second blades.

6. The vibration damper as claimed in claim 1, wherein the conic surface extends partially around the longitudinal axis.

7. The vibration damper as claimed in claim 1, wherein the conic surface extends as a half cone from a mid-plane through the longitudinal axis.

8. The vibration damper as claimed in claim 1, wherein the conic surface is provided with a surface roughness Ra in the range of 0.1 to 50 μm.

9. A rotor device for a gas turbine engine comprising:
a disc wheel;
at least two blades extending radially from the disc wheel; and
at least one vibration damper as claimed in claim 1.

10. The rotor device as claimed in claim 9, wherein the longitudinal axis of the elongate damper body subtends an angle with an axis of rotation of the disc wheel.

11. A gas turbine engine for an aircraft comprising:
an engine core comprising a turbine, a compressor, and a core shaft connecting the turbine to the compressor;
a fan located upstream of the engine core, the fan comprising a plurality of fan blades; and
a gearbox that receives an input from the core shaft and outputs drive to the fan so as to drive the fan at a lower rotational speed than the core shaft,
wherein at least one of the turbine and the compressor comprises a rotor device as claimed in claim 10.

12. The gas turbine engine according to claim 11, wherein:
the turbine is a first turbine, the compressor is a first compressor, and the core shaft is a first core shaft;
the engine core further comprises a second turbine, a second compressor, and a second core shaft connecting the second turbine to the second compressor; and
the second turbine, second compressor, and second core shaft are arranged to rotate at a higher rotational speed than the first core shaft.
